(19) United States
(12) Patent Application Publication
(10) Pub. No.: US 2010/0079428 A1
(43) Pub. Date: Apr. 1, 2010

(54) ELECTROPHORETIC DISPLAY DEVICE, ELECTRONIC APPARATUS, AND METHOD FOR DRIVING ELECTROPHORETIC DISPLAY DEVICE

(75) Inventor: Kiichi Kajino, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/559,590

(22) Filed: Sep. 15, 2009

(30) Foreign Application Priority Data
Oct. 1, 2008 (JP) 2008-256095

(51) Int. Cl. G09G 3/34; G09G 5/00

(52) U.S. Cl. 345/208; 345/107

(57) ABSTRACT

An electrophoretic display device is provided. The electrophoretic display device includes: a pixel electrode; a counter electrode that is provided opposite to the pixel electrode; an electrophoretic element being sandwiched between the pixel electrode and the counter electrode; a pixel switching element; a capacitor that is connected to the pixel switching element; a switching circuit that is provided between the capacitor and the pixel electrodes; a first control line that is connected to the switching circuit; and a second control line that is connected to the switching circuit. The switching circuit performs switching operation on the basis of a signal outputted from the capacitor for a connection state switchover so as to connect either the first control line or the second control line to the pixel electrode.

### BACKGROUND

1. Technical Field

The present invention relates to an electrophoretic display device, an electronic apparatus, and a method for driving an electrophoretic display device.

2. Related Art

An electrophoretic display device is provided with, for example, a pair of electrodes and an electrophoretic element that is sandwiched between the pair of electrodes. The electrophoretic element includes electrophoretic particles. A voltage is applied to the pair of electrodes to drive the electrophoretic element for display. A desired display image can be obtained as a result of the above operation performed for each pixel. In such driving operation, for example, an image signal supplied via a switching element is temporarily stored into a memory circuit. The image signal is then inputted into a pixel electrode so as to set the voltage level of the pixel electrode. When the potential is applied to the pixel electrode, there arises an electrical potential difference between the pixel electrode and a counter electrode. The electrophoretic element is driven due to the potential difference generated therebetween. As a result, an image is displayed. An example of such electrophoretic display operation is disclosed in JP-A-2008-139737. In addition, a configuration for retaining an electric potential at a capacitor is disclosed in the publication identified above.

However, in order to operate an electrophoretic display device for image display, it is necessary to apply a voltage to a pair of electrodes sandwiching an electrophoretic element so as to generate an electrical potential difference that is large enough to drive the electrophoretic display device between the electrodes. For example, it is necessary to generate a potential difference of 10V or greater. In addition, the application of the voltage has to continue for a certain time period, for example, approximately one second.

Since a current leakage path via an electrophoretic element exists between one pixel electrode and another, there is a problem in that charge loss occurs at a capacitor due to current leakage. Since an electrical potential difference decreases due to charge loss, it is necessary to re-apply a potential to the capacitor from the outside in order to keep a sufficient potential difference, which is another problem remains to be solved.

### SUMMARY

In order to address the above-identified problems without any limitation thereto, the invention provides, as various aspects thereof, an electrophoretic display device, an electronic apparatus, and a method for driving an electrophoretic display device having the following novel and inventive features.

Application Example 1 (First Aspect): An electrophoretic display device having a display area that is made up of a plurality of pixels, the electrophoretic display device including: a pair of substrates; an electrophoretic element that includes electrophoretic particles, the electrophoretic element being sandwiched between one of the pair of substrates and the other thereof; a plurality of pixel electrodes each of which is provided in the corresponding one of the plurality of pixels inside the display area; a counter electrode that is provided opposite to the plurality of pixel electrodes with the electrophoretic element being sandwiched between the counter electrode and the plurality of pixel electrodes; a first control line that is connected to each of the plurality of pixels; and a second control line that is connected to each of the plurality of pixels, wherein each of the plurality of pixels includes a pixel switching element, a capacitor that is connected to the pixel switching element, and a switching circuit that is provided between the capacitor and the corresponding one of the plurality of pixel electrodes, and the switching circuit performs switching operation on the basis of a signal outputted from the capacitor for a connection state switchover so as to connect either the first control line or the second control line to the corresponding one of the plurality of pixel electrodes.

In the operation of an electrophoretic display device according to the first aspect of the invention, an image signal that is inputted into a capacitor is used for the switching operation of a switching circuit that electrically connects either a first control line or a second control line to a pixel electrode. A potential input to the pixel electrode is supplied through either the first control line or the second control line. With such a configuration, the electrophoretic display device is driven through the first control line or the second control line connected to the pixel electrode. Therefore, it is possible to prevent the occurrence of charge loss at the capacitor due to current leakage. Therefore, it is possible to prevent the electric potential of the pixel electrode from lowering. In addition, it is possible to reduce the number of times of the application of a potential to the capacitor. With the above configuration, it is possible to control a voltage level inputted into the pixel electrode through the first control line or the second control line irrespective of an image signal that is inputted into the capacitor, thereby controlling the display state of the pixel. With the above configuration, preparatory display operation such as full-screen white display and full-screen black display can be performed without any need to transfer an image signal to a pixel. Therefore, it is possible to save power for preparatory display operation. Moreover, it is possible to apply a voltage to some desired pixels only by setting the first control line or the second control line into a high impedance state or setting the first control line or the second control line at the same level as a level of the counter electrode.

Application Example 2: It is preferable that the electrophoretic display device according to the first aspect of the invention should further include: a plurality of scanning lines that is connected to the plurality of pixel switching elements; a plurality of data lines that is connected to the plurality of pixel switching elements; a pixel driving section that supplies an image signal to the capacitor through the data line via the pixel switching element; and a level controlling section that is connected to the first control line, the second control line, and the counter electrode, wherein the level controlling section supplies a voltage that is to be applied to the pixel electrode to the switching circuit through each of the first control line and the second control line and further supplies a rectangular wave that alternates between a first level and a second level for at least one cycle to the counter electrode, and the first level and the second level correspond to levels supplied to the first control line and the second control line. With the preferred configuration described above, it is possible to perform binary control on the level of a voltage that is supplied to the first control line, the second control line, and the counter electrode with the use of two values. Such binary control is advantageous in that it is possible to achieve a low-voltage configuration with simple circuitry.

Application Example 3: In the configuration of the electrophoretic display device according to the first aspect of the invention, it is preferable that the switching circuit should include a signal generation circuit that outputs a first signal and a second signal that are different from each other in accordance with the signal outputted from the capacitor, a first switching element that electrically connects the first control line to the pixel electrode upon receiving the first signal, and a second switching element that electrically connects the second control line to the pixel electrode upon receiving the second signal. With the preferred configuration described above, it is possible to electrically connect either one of the first control line and the second control line to the pixel electrode while disconnecting the other therefrom in accordance with the signal outputted from the capacitor.

Application Example 4: In the configuration of the electrophoretic display device of the above application example, the signal generation circuit may be an inverter.

Application Example 5: In the configuration of the electrophoretic display device of the above application example, the signal generation circuit may be a level shifter.

Application Example 6: In the configuration of the electrophoretic display device of the above application example, each of the first switching element and the second switching element may be a transfer gate.

Application Example 7: In the configuration of the electrophoretic display device of the above application example, each of the first switching element and the second switching element may be an n-type transistor.

Application Example 8: In the configuration of the electrophoretic display device of the above application example, each of the first switching element and the second switching element may be a p-type transistor.

Application Example 9: In the configuration of the electrophoretic display device according to the first aspect of the invention, the switching circuit may include a p-type transistor whose gate terminal is connected to an output terminal of the capacitor and an n-type transistor whose gate terminal is also connected to the output terminal of the capacitor; the p-type transistor may be provided between the pixel electrode and either one of the first control line and the second control line; and the n-type transistor may be provided between the pixel electrode and the other of the first control line and the second control line that is not connected to the p-type transistor. In the preferred configuration described above, either the p-type transistor or the n-type transistor is driven in accordance with the signal outputted from the capacitor. Accordingly, it is possible to electrically connect either one of the first control line and the second control line to the pixel electrode while disconnecting the other therefrom.

Application Example 10: In the configuration of the electrophoretic display device according to the first aspect of the invention, it is preferable that each of the first control line and the second control line should be a common line that is shared by the plurality of pixels.

Application Example 11: In the configuration of the electrophoretic display device according to the first aspect of the invention, it is preferable that each of the first control line and the second control line should double as a control line and another global line.

Application Example 12: An Electronic Apparatus is provided with the electrophoretic display device according to the first aspect of the invention as a display unit thereof.

Application Example 13 (Second Aspect): A method for driving an electrophoretic display device having a display area that is made up of a plurality of pixels, the electrophoretic display device including a pair of substrates, an electrophoretic element that includes electrophoretic particles, the electrophoretic element being sandwiched between one of the pair of substrates and the other thereof, a plurality of pixel electrodes each of which is provided in the corresponding one of the plurality of pixels inside the display area, a counter electrode that is provided opposite to the plurality of pixel electrodes with the electrophoretic element being sandwiched between the counter electrode and the plurality of pixel electrodes, a first control line that is connected to each of the plurality of pixels, and a second control line that is connected to each of the plurality of pixels, each of the plurality of pixels including a pixel switching element, a capacitor that is connected to the pixel switching element, and a switching circuit that performs switching operation on the basis of a signal outputted from the capacitor for a connection state switchover so as to connect either the first control line or the second control line to the corresponding one of the plurality of pixel electrodes, the driving method including: a first operation of inputting an image signal into the capacitor via the pixel switching element; and a second operation of supplying a first level and a second level to the first control line and the second control line, respectively, operating the switching circuit on the basis of the signal outputted from the capacitor so as to input a level into the pixel electrode from either the first control line or the second control line, and inputting a rectangular wave that alternates between the first level and the second level for at least one cycle into the counter electrode.

The driving method includes the operation of inputting an image signal into a capacitor and the operation of performing display on the basis of the image signal retained in the capacitor. Accordingly, it is possible to control a voltage level inputted into the pixel electrode through the first control line or the second control line irrespective of an image signal that is inputted into the capacitor, thereby controlling the display state of the pixel. Therefore, preparatory display operation such as full-screen white display and full-screen black display can be performed without any need to update the image signal retained in the capacitor. Thus, it is possible to save power for preparatory display operation. In addition, a rectangular wave that alternates between the first level and the second level is inputted into the counter electrode. A driving method that is named as “pulsed common level switchover drive scheme” in this specification is adopted. The pulsed common level switchover drive scheme makes it possible to perform binary control on the level of a voltage that is applied to the pixel electrode and the level of a voltage that is applied to the common electrode with the use of two values, that is, a high electric potential (H) and a low electric potential (L). Such binary control is advantageous in that it is possible to achieve low-voltage operation with simple circuitry.

Application Example 14: In the method for driving an electrophoretic display device according to the second aspect of the invention, it is preferable that a first image signal should be inputted into the capacitor of each of pixels that display a first gradation whereas a second image signal should be inputted into the capacitor of each of pixels that display a second gradation in the first operation, and the switching circuit should be operated on the basis of the signal outputted from the capacitor that retains the first image signal in each of the pixels that display the first gradation so as to make the first control line connected to the pixel electrode whereas the switching circuit should be operated on the basis of the signal outputted from the capacitor that retains the second image signal in each of the pixels that display the second gradation so as to make the second control line connected to the pixel electrode in the second operation.

Application Example 15: In the method for driving an electrophoretic display device according to the second aspect of the invention, it is preferable that signals having the same level should be supplied to the first control line and the second control line so that all of the pixels display the same gradation in the second operation.

Application Example 16: In the method for driving an electrophoretic display device according to the second aspect of the invention, it is preferable that the second operation should include a first display operation of setting the first control line into an electrically disconnected high impedance state and supplying the second level to the second control line so as to switch the display of pixels that occupy at least a part of the display area over from the first gradation to the second gradation and a second display operation of supplying the first level to the first control line and setting the second control line into an electrically disconnected high impedance state so as to switch the display of pixels that occupy at least a part of the display area over from the second gradation to the first gradation.

Application Example 17: In the method for driving an electrophoretic display device according to the second aspect of the invention, it is preferable that the second operation should include a first display operation of setting the first control line at the same level as a level of the counter electrode and supplying the second level to the second control line so as to switch the display of pixels that occupy at least a part of the display area over from the first gradation to the second gradation and a second display operation of supplying the first level to the first control line and setting the second control line at the same level as a level of the counter electrode so as to switch the display of pixels that occupy at least a part of the display area over from the second gradation to the first gradation.

Application Example 18: In the method for driving an electrophoretic display device according to the second aspect of the invention, it is preferable that the first display operation and the second display operation should be repeated so as to update a display image in the second operation.

Application Example 19: It is Preferable that the method for driving an electrophoretic display device according to the second aspect of the invention should further include an operation of setting the capacitor, the switching circuit, and the counter electrode into an electrically disconnected high impedance state after the second operation.

### BRIEF DESCRIPTION OF THE DRAWINGS

The invention will be described with reference to the accompanying drawings, wherein like numbers reference like elements.

FIG. 1 is a general circuit diagram that schematically illustrates an example of the electric configuration of an electrophoretic display device according to an exemplary embodiment of the invention.

FIG. 2 is a diagram that schematically illustrates an example of the circuit configuration of a pixel of an electrophoretic display device according to a first embodiment of the invention.

FIG. 3 is a sectional view that schematically illustrates an example of the partial configuration of a display area of an electrophoretic display device according to an exemplary embodiment of the invention.

FIG. 4 is a diagram that schematically illustrates an example of the configuration of a microcapsule.

FIGS. 5A and 5B are a set of diagrams that schematically illustrates an example of the operation of a microcapsule.

FIG. 6 is a timing chart that schematically illustrates an example of a first driving method according to the first embodiment of the invention.

FIG. 7 is a timing chart that schematically illustrates an example of a second driving method according to the first embodiment of the invention.

FIG. 8 is a diagram that schematically illustrates an example of the circuit configuration of a pixel according to a first configuration example of a second embodiment of the invention.

FIG. 9 is a diagram that schematically illustrates an example of the circuit configuration of a pixel according to a second configuration example of the second embodiment of the invention.

FIG. 10 is a diagram that schematically illustrates an example of the circuit configuration of a pixel according to a third configuration example of the second embodiment of the invention.

FIG. 11 is a perspective view that schematically illustrates an example of the configuration of a sheet of electronic paper, which is an example of an electronic apparatus according to an aspect of the invention.

FIG. 12 is a perspective view that schematically illustrates an example of the configuration of an electronic notebook, which is an example of an electronic apparatus according to an aspect of the invention.

FIG. 13 is a diagram that schematically illustrates an example of the circuit configuration of a pixel according to a variation example in which a line doubles as a control line and a power supply line.

### DESCRIPTION OF EXEMPLARY EMBODIMENTS

With reference to the accompanying drawings, exemplary embodiments of the present invention will now be explained in detail. In the accompanying drawings that will be mentioned in the following description of this specification, different scales are used for layers/members illustrated therein so that each of the layers/members has a size that is easily recognizable therein.

### First Embodiment

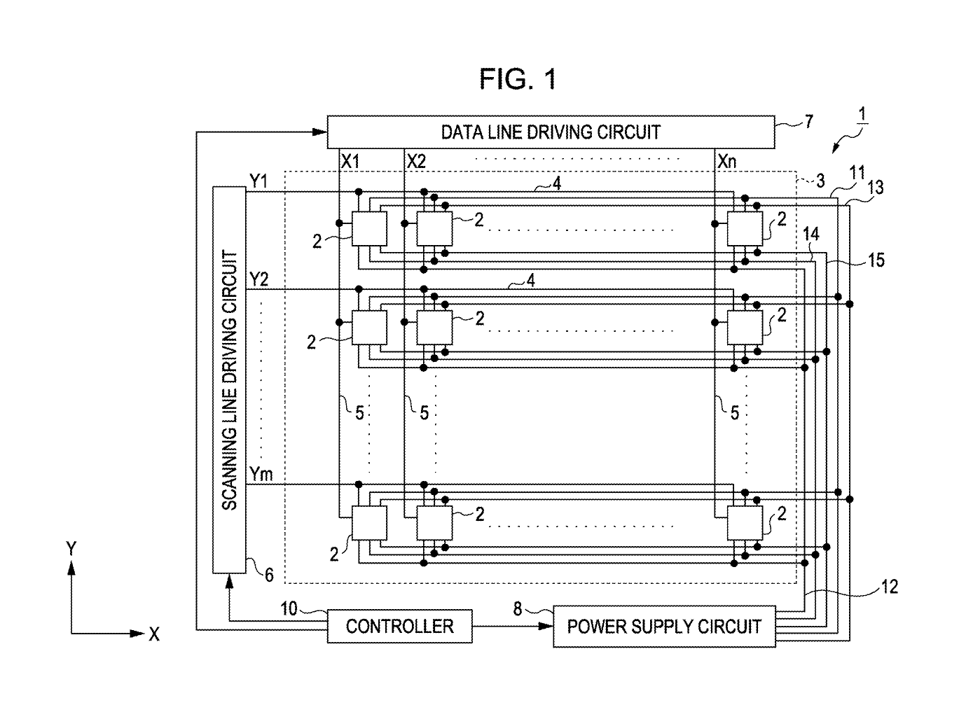

An electrophoretic display device according to a first embodiment of the invention is explained below while referring to the accompanying drawings. FIG. 1 is a general circuit diagram that schematically illustrates an example of the electric configuration of an electrophoretic display device according to an exemplary embodiment of the invention.

The electrophoretic display device 1 is provided with a display unit 3, a scanning line driving circuit 6, a data line driving circuit 7, a power supply circuit 8, and a controller 10. The power supply circuit 8 is an example of a level (i.e., potential) controlling section according to an aspect of the invention. A combination of the scanning line driving circuit 6 and the data line driving circuit 7 corresponds to, as an example of, a pixel driving section according to an aspect of the invention.

A plurality of pixels 2 is formed on the display area 3. The pixels 2 are arranged in an m X n matrix pattern. Specifically, m pixels 2 are arrayed in the Y direction, whereas n pixels 2 are arrayed in the X direction. The scanning line driving circuit 6 is connected to the pixels 2 via a plurality of scanning lines 4 (Y1, Y2, . . . , Ym). Each of the scanning lines 4 extends in the X-axis direction on the display area 3. The data line driving circuit 7 is connected to the pixels 2 via a plurality of data lines 5 (X1, X2, . . . , Xn). Each of the data lines 5 extends in the Y-axis direction on the display area 3. The power supply circuit 8 is connected to the plurality of pixels 2 via a first control line 11, a second control line 12, a first power supply line 13, a second power supply line 14, and a common electrode power supply line 15. The controller 10 controls the operation of each of the scanning line driving circuit 6, the data line driving circuit 7, and the power supply circuit 8. Each of the first control line 11, the second control line 12, the first power line 13, the second power line 14, and the common electrode power supply line 15 constitutes a common line that is shared by all of the pixels 2.

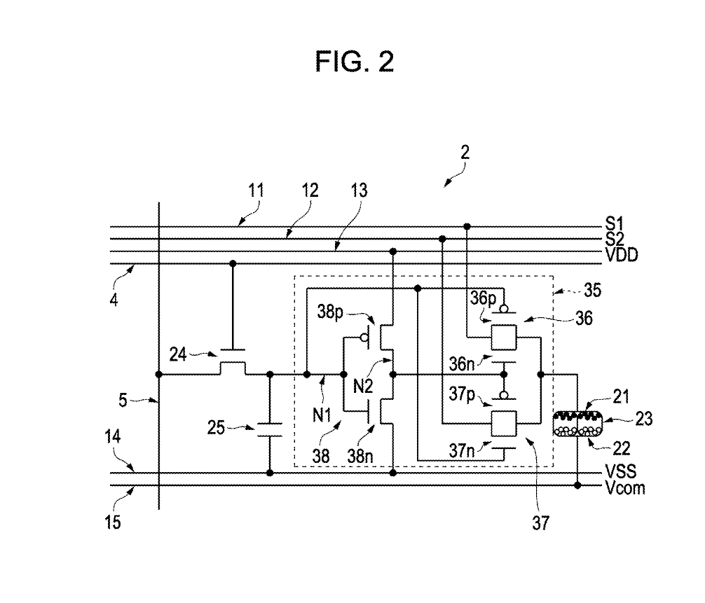

FIG. 2 is a diagram that schematically illustrates an example of the circuit configuration of a certain pixel of an electrophoretic display device according to a first embodiment of the invention. The pixel 2 is made up of a driving thin film transistor (hereafter abbreviated as “TFT”) 24, a capacitor 25, a switching circuit 35, a first electrode 21, a second electrode 22, and an electrophoretic element 23. The driving TFT 24 is an example of a pixel switching element according to an aspect of the invention.

The first electrode 21 is a pixel electrode. The second electrode 22 is a common electrode. The common electrode 22 is an example of a counter electrode according to an aspect the invention.

The driving TFT 24 is a negative metal oxide semiconductor (hereafter abbreviated as N-MOS). The gate electrode of the driving TFT 24 is connected to the scanning line 4. The source electrode of the driving TFT 24 is connected to the data line 5. The drain electrode of the driving TFT 24 is connected to the capacitor 25. Throughout a time period in which a selection signal is being inputted into the driving TFT 24 from the scanning line driving circuit 6 via the scanning line 4, the data line 5 is electrically connected to the capacitor 25 via the driving TFT 24. An image signal that is supplied as an input to the driving TFT 24 from the data line driving circuit 7 via the data line 5 is further inputted into the capacitor 25 through the electric connection established by the driving TFT 24 upon the application of the selection signal thereto.

The switching circuit 35 is provided with a first transfer gate 36, a second transfer gate 37, and a signal generation circuit 38. The first transfer gate 36 includes a P-MOS 36p and an N-MOS 36n. The second transfer gate 37 includes a P-MOS 37p and an N-MOS 37n. The signal generation circuit 38 is a circuit that generates at least two types of signals including an original signal. The signal generation circuit 38 is an inverter that is made up of a P-MOS 38p and an N-MOS 38n. Notwithstanding the above, a level shifter may be used for the signal generation circuit 38 as a substitute for an inverter.

The source terminal of the first transfer gate 36 is connected to the first control line 11. The source terminal of the second transfer gate 37 is connected to the second control line 12. The drain terminal of the first transfer gate 36 is connected to the pixel electrode 21. The drain terminal of the second transfer gate 37 is also connected to the pixel electrode 21. The capacitor 25 is connected to the gate terminal of each of the P-MOS 38p, the N-MOS 38n, the P-MOS 36p, and the N-MOS 37n. This terminal is hereafter denoted as N1. The source terminal of the P-MOS 38p is connected to the first power supply line 13. The source terminal of the N-MOS 38n is connected to the second power supply line 14. The drain terminals of the P-MOS 38p and the N-MOS 38n are connected to the gate terminals of the N-MOS 36n and the P-MOS 37p (hereafter denoted as N2). The electric potential (voltage level) of the terminal N1 of the capacitor 25 corresponds to an output signal of the capacitor 25.

The capacitor 25 is used for retaining an image signal sent from the driving TFT 24 and inputting the image signal into the switching circuit 35. The switching circuit 35 functions as a selector that selects either the first control line 11 or the second control line 12 on the basis of the image signal inputted from the capacitor 25 so as to connect the selected one of the first control line 11 and the second control line 12 to the pixel electrode 21. When the switching circuit 35 functions as a selector, either the first transfer gate 36 or the second transfer gate 37 operates in accordance with the level of the supplied image signal.

Specifically, when a signal of a high level (H) is inputted into the capacitor 25 as the image signal, the terminal N1 is set at the high level (H). Accordingly, the N-MOS 37n operates among a plurality of transistors connected to the terminal N1. In addition, a signal of a low level (L) is outputted from the terminal N2 opposite the terminal N1 through the signal generation circuit (e.g., inverter) 38. Accordingly, the P-MOS 37p operates among a plurality of transistors connected to the terminal N2. As a result, the second transfer gate 37 is driven. Therefore, an electric connection is established between the second control line 12 and the pixel electrode 21. On the other hand, when a signal of the low level (L) is inputted into the capacitor 25 as the image signal, the terminal N1 is set at the low level (L). A signal of the high level (H) is outputted from the terminal N2. Accordingly, the P-MOS 36p, which is connected to the terminal N1, and the N-MOS 36n, which is connected to the terminal N2, enter into an operation state, resulting in the activation of the first transfer gate 36. Since the first transfer gate 36 is driven, an electric connection is established between the first control line 11 and the pixel electrode 21. As explained above, the first control line 11 becomes connected to the pixel electrode 21 via the first transfer gate 36, or the second control line 12 becomes connected to the pixel electrode 21 via the second transfer gate 37, the selection of which depends on which one of these two transfer gates is activated. As a result, the electric potential of either the first control line 11 or the second control line 12 is inputted into the pixel electrode 21.

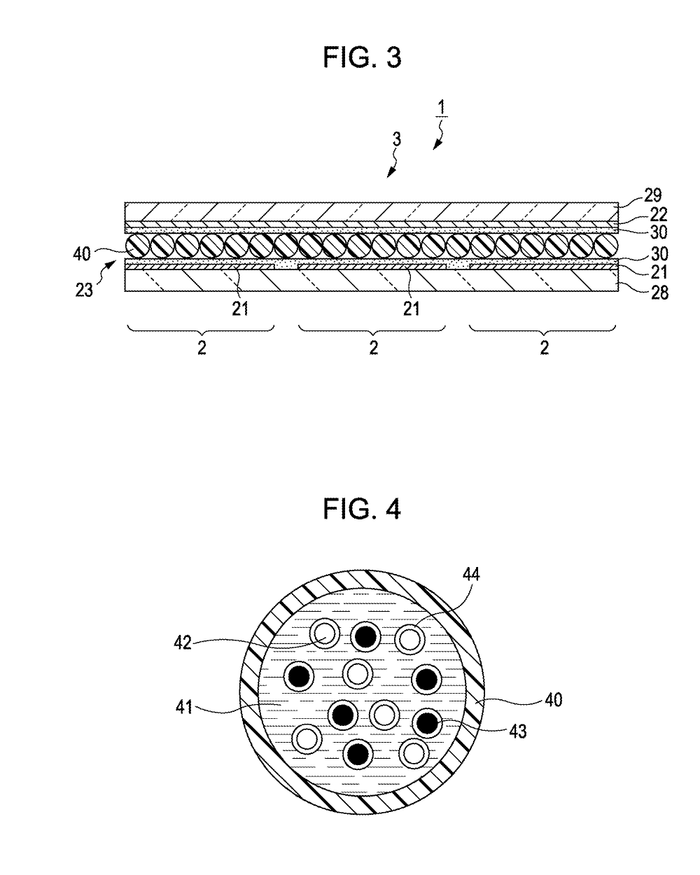

The electrophoretic element 23 functions to display an image as a result of the migration of electrophoretic particles due to a difference between an electric potential applied to the pixel electrode 21 and an electric potential applied to the common electrode 22. The common electrode 22 is electrically connected to the common electrode power supply line 15. FIG. 3 is a sectional view that schematically illustrates an example of the partial configuration of the display area 3 of the electrophoretic display device 1 according to an exemplary embodiment of the invention. In the structure of the display unit 3 of the electrophoretic display device 1, the electrophoretic element 23 is sandwiched between an element substrate 28 and a counter substrate 29, which is provided opposite to the element substrate 28. The element substrate 28 has the pixel electrodes 21, whereas the counter substrate 29 has the common electrode 22. The electrophoretic element 23 is made up of a plurality of microcapsules 40. The electrophoretic element 23 is fixed between the element substrate 28 and the counter substrate 29 by means of an adhesive, which constitutes layers. These layers, or either one of them, are hereafter referred to as adhesive layer(s) 30. One of these adhesive layers 30 is sandwiched between the electrophoretic element 23 and the element substrate 28. The other thereof is sandwiched between the electrophoretic element 23 and the counter substrate 29. The element-substrate-side adhesive layer 30, which is one that is provided closer to the element substrate 28, is an indispensable layer that is used for the bonding of the electrophoretic element 23 to the surface of the pixel electrodes 21, whereas the counter-substrate-side adhesive layer 30, which is provided closer to the counter substrate 29, is “dispensable”. The reason why the counter-substrate-side adhesive layer 30 can be said as dispensable is as follows. The common electrode 22, the plurality of microcapsules 40, and the counter-substrate-side adhesive layer 30 may have been formed through a series of pre-manufacturing processes over the counter substrate 29 into an electrophoretic sheet, which is later bonded to the surface of the pixel electrodes 21 in a subsequent manufacturing step. In such a case, it is one adhesive layer 30 provided closer to the element substrate 28 only that constitutes an indispensable adhesive layer.

The element substrate 28 is a substrate that is made of, for example, glass, plastic, or the like. The pixel electrodes 21 are formed on the element substrate 28. The pixel electrode 21 is formed as a rectangular electrode for each of the pixels 2. Though not illustrated in the drawing, the scanning line 4, the data line 5, the first control line 11, the second control line 12, the first power supply line 13, the second power supply line 14, the common electrode power supply line 15, the driving TFT 24, the capacitor 25, and the switching circuit 35, which are explained above while referring to FIGS. 1 and 2, are formed in a gap area between each two pixel electrodes 21 arrayed adjacent to each other and in a layer under the pixel electrode 21 close to the element substrate 28.

The counter substrate 29 serves as an image-display-side substrate. Therefore, the counter substrate 29 is made of a transparent material such as glass or the like. A material that has both optical transparency and electric conductivity is used for the formation of the common electrode 22 on the counter substrate 29. As examples of such a transparent and conductive material, magnesium silver (MgAg), indium tin oxide (ITO), indium zinc oxide (IZO), or the like may be used. It is common practice in the manufacturing of an electrophoretic display device to prepare a pre-manufactured electrophoretic sheet, which includes the counter-substrate-side layers including the adhesive layer 30 provided closer to the counter substrate 29. In such a case, the electrophoretic element 23 is pre-built as a part of the electrophoretic sheet on the counter-substrate-side adhesive layer 30. A sheet of release-coated paper is pasted at the adhesive-layer (30) side thereof for protection. In a manufacturing step, the release-coated paper is peeled off. After the removal thereof, the pre-manufactured electrophoretic sheet is bonded to the element substrate 28 on the surface of which the pixel electrodes 21 as well as the components and circuitry explained above have been formed in advance in a separate process. The display unit 3 is formed as a result of the bonding of the electrophoretic sheet to the element substrate 28. Therefore, in a typical layer structure of an electrophoretic display device, the adhesive layer 30 exists only on the pixel electrodes 21.

FIG. 4 is a diagram that schematically illustrates an example of the configuration of the microcapsule 40. The microcapsule 40 has a diameter of, for example, approximately 50 μm. The microcapsule 40 is made of, for example, an acrylic resin including but not limited to polymethyl methacrylate or polyethyl methacrylate, a urea resin, a polymeric resin having optical transparency such as gum arabic or the like. The microcapsule 40 is sandwiched between the common electrode 22 and the pixel electrode 21. The plurality of microcapsules 40 is arrayed vertically and horizontally in each of the pixels 2. A binder is provided therein so as to fill each gap between the microcapsules 40, thereby supporting the microcapsules 40 in a stable manner. Note that the binder is not illustrated in the drawing. A dispersion medium 41, a plurality of white particles 42, and a plurality of black particles 43 are encapsulated inside the microcapsule 40. The plurality of white particles 42 and the plurality of black particles 43 behave as electrophoretic particles. Each of the plurality of white particles 42 and black particles 43 is electrically charged.

The dispersion medium 41 is a liquid, the presence of which enables the white particles 42 and the black particles 43 to be dispersed inside the microcapsule 40. The dispersion medium 41 can be formed as a compound of a surfactant (i.e., surface-active agent) and either a single chemical element/material/substance or combined chemical elements/materials/substances that is/are selected from, without any intention to limit thereto: water, alcohol solvent such as methanol, ethanol, isopropanol, butanol, octanol, methyl cellosolve or the like, ester kinds such as ethyl acetate, butyl acetate or the like, ketone kinds such as acetone, methyl ethyl ketone, methyl isobutyl ketone or the like, aliphatic hydrocarbon such as pentane, hexane, octane or the like, alicyclic hydrocarbon such as cyclohexane, methylcyclohexane or the like, aromatic hydrocarbon such as benzene kinds having a long-chain alkyl group such as benzene, toluene, xylene, hexyl benzene, butyl benzene, octyl benzene, nonyl benzene, decyl benzene, undecyl benzene, dodecyl benzene, tridecyl benzene, tetradecyl benzene or the like, halogenated hydrocarbon such as methylene chloride, chloroform, carbon tetrachloride, 1,2-dichloroethane or the like, carboxylate, or any other kind of oil and fat.

The white particle 42 is structured as, for example, a particle (i.e., high polymer or colloid) made of white pigment such as titanium dioxide, hydrozincite, antimony trioxide or the like. For example, the white particle 42 is charged negatively. On the other hand, the black particle 43 is structured as, for example, a particle (i.e., high polymer or colloid) made of black pigment such as aniline black, carbon black or the like. For example, the black particle 43 is charged positively. Having such particle property, each of the plurality of white particles 42 and the plurality of black particles 43 can move in an electric field that is generated due to a potential difference between the pixel electrode 21 and the common electrode 22 in the dispersion medium 41.

If necessary, a charge-controlling agent, a dispersing agent, a lubricant, a stabilizing agent, or the like, may be added to these pigments. The charge-controlling agent may be made of particles of, for example, electrolyte, surface-active agent, metallic soap, resin, gum, oil, varnish, or compound, though not limited thereto. The dispersing agent may be a titanium-system coupling agent, an aluminum-system coupling agent, a silane-system coupling agent, though not limited thereto.

An ion existing in the solvent covers each of the white particles 42 and the black particles 43. Therefore, an ion layer 44 is formed on the surface of each of the white particles 42 and the black particles 43. An electric double layer is formed each between the electrically-charged white particle 42 and the ion layer 44 as well as each between the electrically-charged black particle 43 and the ion layer 44. Generally speaking, it is known in the art that electrically charged particles such as the white particles 42 and the black particles 43 do not react even when an electric field of 10 kHz frequency or greater is applied thereto. Therefore, even when such an electric field is applied thereto, these electrically charged particles hardly move. In contrast, it is known in the art that an ion that surrounds each of these charged particles moves when an electric field of 10 kHz frequency or greater is applied thereto because the ion has a far smaller diameter in comparison with that of the charged particle.

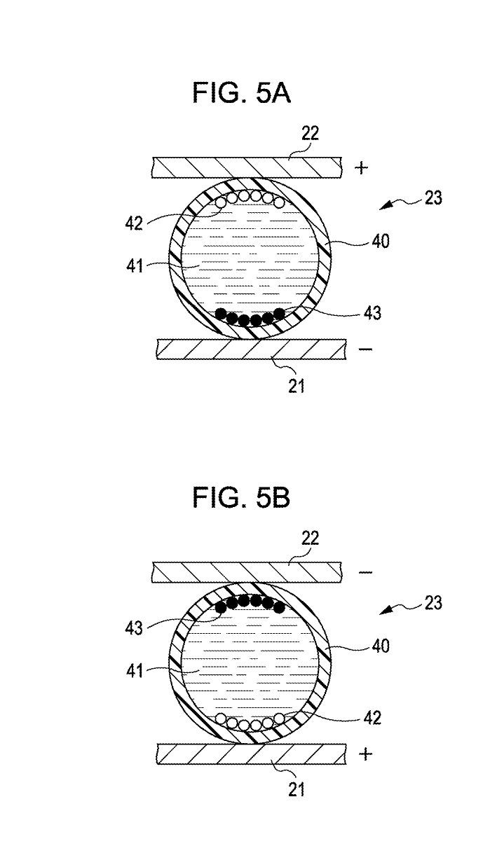

FIGS. 5A and 5B is a set of diagrams that schematically illustrates an example of the operation of the microcapsule 40. In the following description, the operation of the microcapsule 40 is explained while taking an ideal case where the ion layer 44 is not formed as an example. For example, a voltage is applied in such a manner that the voltage level of the common electrode 22 is relatively high in comparison with that of the pixel electrode 21. Upon the application of such a relatively low voltage to the pixel electrode 21, as illustrated in FIG. 5A, the black particles 43, which are positively charged, are drawn to the pixel-electrode (21) side in the microcapsule 40 due to Coulomb force. On the other hand, the white particles 42, which are negatively charged, are drawn to the common-electrode (22) side in the microcapsule 40 due to Coulomb force. Accordingly, the white particles 42 gather at the display-surface side of the microcapsule 40, which is the common-electrode side. As a result, the color of the white particle 42, that is, white, is displayed on the display surface.

Next, it is assumed that the voltage levels are reversed. That is, a voltage is applied in such a manner that the voltage level of the pixel electrode 21 is relatively high in comparison with that of the common electrode 22. Upon the application of such a relatively high voltage to the pixel electrode 21, as illustrated in FIG. 5B, the white particles 42, which are negatively charged, are drawn to the pixel-electrode (21) side in the microcapsule 40 due to Coulomb force. On the other hand, the black particles 43, which are positively charged, are drawn to the common-electrode (22) side in the microcapsule 40 due to Coulomb force. Consequently, the black particles 43 gather at the display-surface side of the microcapsule 40. As a result thereof, the color of the black particle 43, that is, black, is displayed on the display surface.

The pigments used for the white particles 42 and the black particles 43 may be replaced by, for example, red, green, and blue one. If so modified, the electrophoretic display device 1 can display, for example, red, green, and blue.

In the configuration of the electrophoretic display device 1 according to an exemplary embodiment of the invention, at least one transistor is interposed between the capacitor 25 and the pixel electrode 21. With such a configuration, charge stored at the capacitor 25 is less susceptible to leakage through the pixel electrode 21 than otherwise. Accordingly, it is possible to retain an image signal at the capacitor 25 for a longer period of time.

### First Driving Method

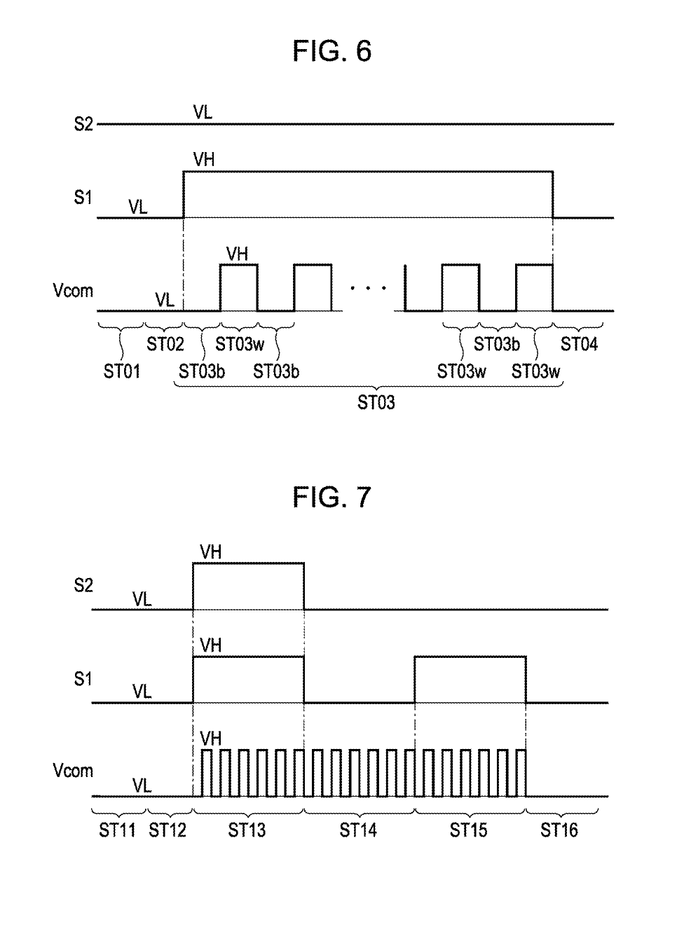

Next, with reference to the accompanying drawings, methods for driving the electrophoretic display device 1 according to the present embodiment of the invention are explained below. FIG. 6 is a timing chart that schematically illustrates an example of a first driving method according to the first embodiment of the invention.

FIG. 6 shows a sequence of timing operations performed for image display. As illustrated therein, one sequence is made up of a power OFF time period ST01, an image signal input time period ST02, black image display time periods ST03b, white image display time periods ST03w, and a power OFF time period ST04. The black image display time periods ST03b and the white image display time periods ST03w are collectively referred to as “image display time period ST03”. The operation is performed in the order of appearance herein in a sequential manner including the alternation of the black image display time periods ST03b and the white image display time periods ST03w throughout the image display time period ST03.

The electric potential S1 of the first control line 11, the electric potential S2 of the second control line 12, and the electric potential Vcom of the common electrode power supply line 15 are shown in FIG. 6.

In the power OFF time period ST01 illustrated in FIG. 6, each of the first power supply line 13, the second power supply line 14, the first control line 11, the second control line 12, and the common electrode 22 is set at a ground level or in an open state (i.e., high impedance state (Hi-Z)) in which it is electrically disconnected from other circuitry. In this period, a preceding display image is retained in the display unit 3.

Next, the image signal input time period ST02 is explained. The image signal input time period ST02 is an example of a first step according to an aspect of the invention. The power supply circuit 8 illustrated in FIG. 1 inputs a signal of a high level into the capacitor 25 illustrated in FIG. 2 via the first power supply line 13. The power supply circuit 8 inputs a signal of a low level into the capacitor 25 via the second power supply line 14. As a result, the capacitor 25 is charged or discharged. Each of the first control line 11, the second control line 12, and the common electrode power supply line 15 is set at a low level (VL) or disconnected electrically (Hi-Z).

The scanning line driving circuit 6 supplies a selection signal to the scanning line Y1 as an input. Among all of the pixels 2, the driving TFT 24 of each of the pixels 2 that are electrically connected to the scanning line Y1 is driven as a result of the application of the selection signal thereto. Consequently, an electric connection is established between the corresponding data lines X1, X2, . . . , and Xn and the capacitors 25 of the pixels 2 that are electrically connected to the scanning line Y1, respectively. The data line driving circuit 7 shown in FIG. 1 supplies an image signal to each of the data lines X1, X2, . . . , and Xn. By this means, the image signal is inputted into each of the capacitors 25 of the pixels 2 that are electrically connected to the scanning line Y1.

After the image signal has been inputted into each of the capacitors 25 of the pixels 2 that are electrically connected to the scanning line Y1, the scanning line driving circuit 6 stops the supplying of the selection signal to the scanning line Y1. As a consequence thereof, the pixels 2 that are electrically connected to the scanning line Y1 are deselected. That is, the selection state thereof is released. Next, the series of operations described above is performed for the pixels 2 that are electrically connected to the scanning line Y2, Y3, . . . in a sequential manner. This is repeated until the pixels 2 that are electrically connected to the scanning line Ym have been selected. By this means, the image signal is inputted into the capacitor 25 of each of all pixels 2. As a result, an electric potential corresponding to the inputted image signal is stored in the capacitor 25 of each of all pixels 2 that make up the display area 3.

Next, the operation enters the image display time period ST03. The image display time period ST03 is an example of a second step according to an aspect of the invention. The image display time period ST03 includes the black image display time periods ST03b and the white image display time periods ST03w, which alternate with each other. Throughout the image display time period ST03, a signal of a high level (VH) is supplied to the first control line 11, whereas a signal of a low level (VL) is supplied to the second control line 12. Accordingly, the source terminal of the first transfer gate 36 is set at a high input level, whereas the source terminal of the second transfer gate 37 is set at a low input level. The high level is, for example, 15V. The low level is, for example, 0V. The input level of the common electrode 22 is set to be low (VL) via the common electrode power supply line 15 in each black image display time period ST03b. The input level of the common electrode 22 is set to be high (VH) via the common electrode power supply line 15 in each white image display time period ST03w. Therefore, a pulse signal that fluctuates between high and low in a predetermined cycle is inputted into the common electrode 22 throughout the image display time period ST03.

The black image display time period ST03b is explained first. As explained above, the input level of the common electrode 22 is set to be low via the common electrode power supply line 15 in each black image display time period ST03b.

In each of the plurality of pixels 2 to which an image signal of a low level has been supplied, the output level of the capacitor 25, that is, the potential of the terminal N1 thereof, is low, whereas the output level of the signal generation circuit 38 (terminal N2) is high. Therefore, the first transfer gate 36 is driven so that the first control line 11 is connected to the pixel electrode 21. As a result, a voltage of a high level is applied to the pixel electrode 21 as an input. Upon the application of the high-level voltage to the pixel electrode 21, a large potential difference, which is a difference between the high voltage level VH and the low voltage level VL, is generated between the pixel electrode 21 and the common electrode 22. Therefore, as illustrated in FIG. 5B, the black particles 43 of the electrophoretic element 23 are drawn to the common electrode 22. The white particles 42 thereof are drawn to the pixel electrode 21. Consequently, each of these pixels 2 displays black.

On the other hand, in each of the plurality of pixels 2 to which an image signal of a high level has been supplied, the output level of the capacitor 25, that is, the potential of the terminal N1 thereof, is high, whereas the output level of the signal generation circuit 38 (terminal N2) is low. Therefore, the second transfer gate 37 is driven so that the second control line 12 is connected to the pixel electrode 21. As a result, a voltage of a low level is applied to the pixel electrode 21 as an input. Therefore, there does not occur a potential difference between the pixel electrode 21 and the common electrode 22. Since no voltage difference is generated therebetween, the electrophoretic particles of the electrophoretic element 23 of the pixel 2 do not migrate. Thus, the preceding image is retained as it is.

Next, the white image display time period ST03w is explained below. As explained earlier, the input level of the common electrode 22 is set to be high via the common electrode power supply line 15 in each white image display time period ST03w.

In each of the plurality of pixels 2 to which an image signal of a high level has been supplied, the output level of the capacitor 25, that is, the potential of the terminal N1 thereof, is high, whereas the output level of the signal generation circuit 38 (terminal N2) is low. Therefore, the second transfer gate 37 is driven so that the second control line 12 is connected to the pixel electrode 21. As a result, a voltage of a low level is applied to the pixel electrode 21 as an input. Upon the application of the low-level voltage to the pixel electrode 21, a large potential difference, which is a difference between the low voltage level VL and the high voltage level VH, is generated between the pixel electrode 21 and the common electrode 22. Therefore, as illustrated in FIG. 5A, the black particles 43 of the electrophoretic element 23 are drawn to the pixel electrode 21. The white particles 42 thereof are drawn to the common electrode 22. Consequently, each of these pixels 2 displays white.

On the other hand, in each of the plurality of pixels 2 to which an image signal of a low level has been supplied, the output level of the capacitor 25, that is, the potential of the terminal N1 thereof, is low, whereas the output level of the signal generation circuit 38 (terminal N2) is high. Therefore, the first transfer gate 36 is driven so that the first control line 11 is connected to the pixel electrode 21. As a result, a voltage of a high level is applied to the pixel electrode 21 as an input. Therefore, there does not occur a potential difference between the pixel electrode 21 and the common electrode 22. Since no voltage difference is generated therebetween, the electrophoretic particles of the electrophoretic element 23 of the pixel 2 do not migrate. Thus, the preceding image is retained as it is.

A reference pulse that alternates between a low level in the black image display time period ST03b and a high level in the white image display time period ST03w in a predetermined cycle is inputted into the common electrode 22 throughout the image display time period ST03 as explained above. Such a driving method is named as “pulsed common level switchover drive scheme” in this specification. The pulsed common level switchover drive scheme is herein defined as a driving method in which a pulse of at least one cycle that alternates between a high level and a low level is inputted into the common electrode 22 throughout, or during, an image rewriting time period.

If the pulsed common level switchover drive scheme defined above is adopted, it is possible to enhance contrast because this driving method achieves the migration of each of black particles 43 and white particles 42 to a destination electrode with increased reliability. Moreover, it is possible to perform binary control on the level of a voltage that is applied to the pixel electrode 21 and the level of a voltage that is applied to the common electrode 22 with the use of two values, that is, a high electric potential (VH) and a low electric potential (VL). Such binary control is advantageous in that it is possible to achieve a low-voltage configuration with simple circuitry. Furthermore, in a case where a thin film transistor (TFT) is used as the switching element of the pixel electrode 21, there is another advantage in that low-voltage drive operation enhances the reliability of the TFT. It is preferable to determine the frequency of the pulsed common level switchover drive operation at an appropriate value on the basis of the specification of the electrophoretic element 23 and the characteristics thereof. In addition, the number of cycles of the operation should be preferably determined on the basis of the specification of the electrophoretic element 23 and the characteristics thereof.

After a new image has been displayed on the display area 3 as explained above, the operation enters the power OFF time period ST04. Upon entering the power OFF time period ST04, the power supply circuit 8 illustrated in FIG. 1 sets each of the first control line 11, the second control line 12, the first power supply line 13, the second power supply line 14, and the common electrode power supply line 15 at a ground level or into a high impedance state with electrical disconnection.

The power OFF time period ST04 makes it possible to retain an image with no power consumption. In addition, since the first control line 11 and the second control line 12, which supply power to the pixel electrodes 21, are either electrically disconnected or set in a ground level, no potential difference between the lines and the pixel electrodes 21 occurs, which contributes to the reduction of a leakage current.

Moreover, it is possible to update display images one after another by repeating the cycle of the image signal input time period ST02, the image display time period ST03 (i.e., the alternation of the black image display time periods ST03b and the white image display time periods ST03w), and the power OFF time period ST04. As a modification example of the timing operation explained above, the sequential order of the black image display time period ST03b and the white image display time period ST03w may be reversed.

If the voltage level of a signal supplied to the first control line 11 and the voltage level of a signal supplied to the second control line 12 are reversed in the operation of the image display time period ST03 after an image signal has been inputted in each capacitor 25, it is possible to display a reverse image. That is, it is possible to easily reverse a display image just by setting S1 at a low level and setting S2 at a high level without any need to input a reverse image signal into the capacitor 25 of each pixel 2.

In a method of driving the electrophoretic display device 1 according to the present embodiment of the invention, an image signal that is inputted into the capacitor 25 is used for the switching operation of a switching circuit that electrically connects either the first control line 11 or the second control line 12 to the pixel electrode 21. A potential input to the pixel electrode 21 is supplied through either the first control line 11 or the second control line 12. With such a configuration, the electrophoretic display device 1 is driven through the first control line 11 or the second control line 12 connected to the pixel electrode 21. Therefore, it is possible to prevent the occurrence of charge loss at the capacitor 25 due to current leakage. Though some charge loss occurs at the capacitor 25 and/or due to escape/leakage to a TFT, generally speaking, it is considered that such charge loss is smaller in comparison with charge loss attributable to escape/leakage to the electrophoretic display device 1. Therefore, it is possible to prevent the electric potential of the pixel electrode 21 from lowering. In addition, it is possible to reduce the number of times of the application of a potential to the capacitor 25.

### Variation Example

In the first driving method explained above, throughout the image display time period ST03, a signal of a high level (VH) is supplied to the first control line 11, whereas a signal of a low level (VL) is supplied to the second control line 12. In addition, the voltage level Vcom of the common electrode 22 alternates between a low level (VL) in each black image display time period ST03b and a high level (VH) in each white image display time period ST03w in a pulsed manner. The first driving method may be modified as follows. In each black image display time period ST03b, a signal of a high level is supplied to the first control line 11, whereas the second control line 12 is set in a high impedance state. The voltage level of the common electrode 22 is set to be low in the black image display time period ST03b. On the other hand, in each white image display time period ST03w, the first control line 11 is set in a high impedance state, whereas a signal of a low level is supplied to the second control line 12. The voltage level of the common electrode 22 is set to be high in the white image display time period ST03w.

In such modified operation, each of the plurality of pixels 2 to which an image signal of a low level has been supplied displays black in the black image display time period ST03b as done in the first driving method explained above, whereas each of the plurality of pixels 2 to which an image signal of a high level has been supplied retains the last image. Each of the plurality of pixels 2 to which an image signal of a high level has been supplied displays white in the white image display time period ST03w, whereas each of the plurality of pixels 2 to which an image signal of a low level has been supplied retains the last image. This is because the second/first control line 12/11 that is set in a high impedance state is connected to the pixel electrode 21 in each pixel 2 that does not display black/white.

With a modified driving method according to this variation example, since the pixel electrode 21 of each pixel 2 that retains the preceding display image without writing gets connected to a control line that is in a high impedance state at the time of the writing of black/white, it is possible to reduce the leakage of a current between some pixels 2 that are subjected to writing and the other pixels 2 that are not.

### Second Driving Method

Next, a second driving method is explained below. The second driving method includes a driving state in which all pixels 2 display white or black. Accordingly, the second driving method can be used for the erasing of an image.

An active matrix type electrophoretic display device performs preparatory display operation so that afterimage will not appear. The preparatory display operation is performed each time when a current image that is now being displayed (i.e., original/old image) is replaced with the next image (i.e., new image). For example, an active-matrix electrophoretic display device performs display on the entire display area in white (hereafter may be referred to as full-screen white display) or performs display on the entire display area in black (full-screen black display). Or, an active-matrix electrophoretic display device repeats full-screen white display and full-screen black display alternately, displays a reverse image of an original image or a new image for a short period of time, or the like. A new image is displayed after such preparatory display operation.

FIG. 7 is a timing chart that schematically illustrates an example of the second driving method according to the first embodiment of the invention. In the illustrated example of FIG. 7, all pixels are controlled to display black first. Thereafter, the pixels are put into a full-screen white display state. Subsequently, an image is displayed.

The electric potential S1 of the first control line 11, the electric potential S2 of the second control line 12, and the electric potential Vcom of the common electrode power supply line 15 are shown in FIG. 7.

FIG. 7 shows a sequence of timing operations performed for image display. As illustrated therein, one sequence is made up of a power OFF time period ST11, an image signal input time period ST12, an all-pixel black display time period ST13, an all-pixel white display time period ST14, an image display time period ST15, and a power OFF time period ST16. The operation is performed in the order of appearance herein in a sequential manner.

The power OFF time period ST11, the image signal input time period ST12, the image display time period ST15, and the power OFF time period ST16 illustrated in FIG. 7 correspond respectively to the power OFF time period ST01, the image signal input time period ST02, the image display time period ST03, and the power OFF time period ST04 of the first driving method. Since the operation of the time periods ST11, ST12, ST15, and ST16 of the second driving method is the same as that of the time periods ST01, ST02, ST03, and ST04 explained earlier, a detailed explanation thereof is omitted here. In the following description, the all-pixel black display time period ST13 and the all-pixel white display time period ST14 are explained, including some mention of the image signal input time period ST12.

As illustrated in FIG. 7, after the completion of the inputting of image signals in the image signal input time period ST12, the operation enters the all-pixel black display time period ST13. Note that the level of image signals that are inputted into the capacitors 25 in the image signal input time period ST12 may be arbitrarily determined, which means that the level thereof does not necessarily have to correspond to a full-screen black image or a full-screen white image.

Upon entering the all-pixel black display time period ST13, the power supply circuit 8 supplies a signal of a high level to each of the first control line 11 and the second control line 12 as an input. Depending on the level of an image signal that is retained in the capacitor 25, either the first transfer gate 36 or the second transfer gate 37 is in a driven state in each of the plurality of pixels 2. Specifically, the first transfer gate 36 is set in an ON state in each of the plurality of pixels 2 to which an image signal of a low level has been supplied. In each of these pixels 2, the first control line 11 is connected to the corresponding pixel electrode 21. The second transfer gate 37 is set in an ON state in each of the plurality of pixels 2 to which an image signal of a high level has been supplied. In each of these pixels 2, the second control line 12 is connected to the corresponding pixel electrode 21.

Since the high-level signals are supplied to both of the first control line 11 and the second control line 12, an input voltage of a high level is applied to the pixel electrode 21 of each of all pixels 2. On the other hand, a pulse signal that alternates between high and low in a predetermined cycle is inputted in the common electrode 22. Therefore, irrespective of whether the level of the image signal retained in the capacitor 25 is high or low, each pixel 2 displays black, resulting in all-black display.

After the all-pixel black display time period ST13, the operation enters the all-pixel white display time period ST14. Upon entering the all-pixel white display time period ST14, the power supply circuit 8 supplies a signal of a low level to each of the first control line 11 and the second control line 12 as an input. Depending on the level of an image signal that is retained in the capacitor 25, either the first transfer gate 36 or the second transfer gate 37 is in a driven state in each of the plurality of pixels 2. Specifically, as explained above, the first transfer gate 36 is set in an ON state in each of the plurality of pixels 2 to which an image signal of a low level has been supplied. In each of these pixels 2, the first control line 11 is connected to the corresponding pixel electrode 21. The second transfer gate 37 is set in an ON state in each of the plurality of pixels 2 to which an image signal of a high level has been supplied. In each of these pixels 2, the second control line 12 is connected to the corresponding pixel electrode 21.

Since the low-level signals are supplied to both of the first control line 11 and the second control line 12, an input voltage of a low level is applied to the pixel electrode 21 of each of all pixels 2. On the other hand, a pulse signal that alternates between high and low in a predetermined cycle is inputted in the common electrode 22. Therefore, irrespective of whether the level of the image signal retained in the capacitor 25 is high or low, each pixel 2 displays white, resulting in all-white display.

After the all-pixel white display time period ST14, which follows the all-pixel black display time period ST13, the operation corresponding to the image display time period ST15 and the power OFF time period ST16 is performed in this order where necessary so as to display an image and then retain the image.

The sequential order of the all-pixel black display time period ST13 and the all-pixel white display time period ST14 may be reversed. If some image signal has already been written in the capacitors 25 of the pixels 2, the power OFF time period ST11 and the image signal input time period ST12 can be omitted. In such a case, the sequence begins with the all-pixel black display time period ST13, followed by the all-pixel white display time period ST14, or vice versa.

As explained above, the second driving method makes it possible to perform full-screen black display or full-screen white display irrespective of whether the level of an image signal retained in the capacitor 25 is high or low. Therefore, for example, after the completion of normal image display, it is possible to perform full-screen black display (or full-screen white display) without rewriting an image signal used for such normal image display at the capacitor 25, which can be achieved just by performing the operation of the all-pixel black display time period ST13 (or the all-pixel white display time period ST14) while retaining the image signal in the capacitor 25.

As explained above, an image change sequence that includes preparatory display operation utilizing full-screen black display or full-screen white display is indispensable to the high-quality display of an electrophoretic display device, for example, display with high contrast free from afterimage. However, in an image change sequence of a related-art electrophoretic display device described in JP-A-2008-139737, it is necessary to transfer full-screen white data, full-screen black data, or reverse image data to pixels at each time when an old image is replaced with new one, which is a cause for an increase in the power consumption of the electrophoretic display device. In contrast, with the use of the second driving method, the electrophoretic display device 1 according to the present embodiment of the invention achieves an efficient image change sequence with reduced power consumption.

### Second Embodiment

Next, an electrophoretic display device according to a second embodiment of the invention is explained below. An electrophoretic display device according to the present embodiment of the invention differs from an electrophoretic display device according to the foregoing first embodiment of the invention in terms of the configuration of a switching circuit. The former is the same as the latter except for the difference in the switching-circuit configuration. Specifically, a switching circuit according to the present embodiment of the invention is made up of, or includes, two transistors, whereas the switching circuit 35 according to the first embodiment of the invention includes two transfer gates, that is, the first transfer gate 36 and the second transfer gate 37. The two transistors of a switching circuit according to the present embodiment of the invention may be hereafter referred to as a first transistor and a second transistor. In the following description of this specification, three exemplary configurations of an electrophoretic display device according to the second embodiment of the invention are explained as a first configuration example, a second configuration example, and a third configuration example.

An electrophoretic display device according to the first configuration example is provided with a switching circuit that is made up of a P-MOS, which functions as the first transistor, and an N-MOS, which functions as the second transistor. An electrophoretic display device according to the second configuration example is provided with a switching circuit that includes a P-MOS functioning as the first transistor and another P-MOS functioning as the second transistor. An electrophoretic display device according to the third configuration example is provided with a switching circuit that includes an N-MOS functioning as the first transistor and another N-MOS functioning as the second transistor.

### First Configuration Example

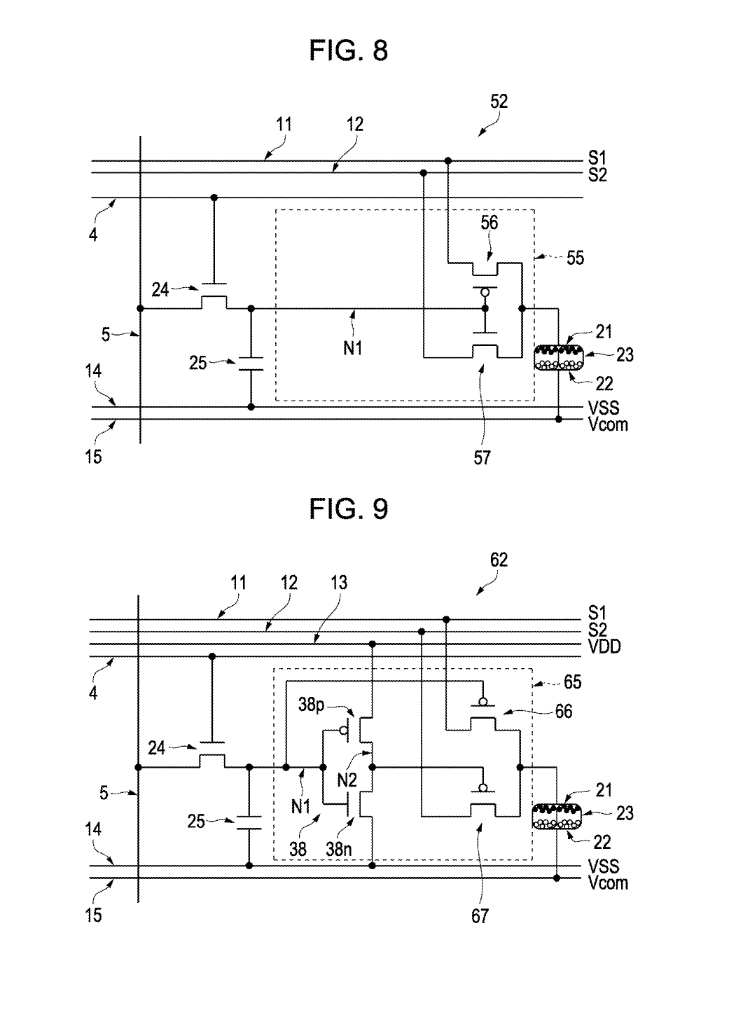

FIG. 8 is a diagram that schematically illustrates an example of the circuit configuration of a pixel 52 according to the first configuration example of the second embodiment of the invention. The pixel 52 illustrated in FIG. 8 includes a switching circuit 55 as a substitute for the switching circuit 35 of the pixel 2 illustrated in FIG. 2. The switching circuit 55 is made up of a P-MOS 56, which functions as the first transistor, and an N-MOS 57, which functions as the second transistor. In the following description of the first configuration example and the illustration of FIG. 8, the same reference numerals are consistently used for the same components as those illustrated in FIG. 2 so as to omit any redundant explanation or simplify explanation thereof.

In the circuit configuration of the pixel 52, the switching circuit 55 is connected between the terminal N1 of the capacitor 25 and the pixel electrode 21. The gate terminal of the P-MOS 56 and the gate terminal of the N-MOS 57 are connected to each other. In addition, the gate terminal of the P-MOS 56 and the gate terminal of the N-MOS 57 are connected the terminal N1 of the capacitor 25. The source terminal of the P-MOS 56 is connected to the first control line 11. The drain terminal of the P-MOS 56 is connected to the pixel electrode 21. The source terminal of the N-MOS 57 is connected to the second control line 12. The drain terminal of the N-MOS 57 is connected to the pixel electrode 21.

When an image signal of a high level is inputted into the pixel 52 having the configuration explained above, the terminal N1 of the capacitor 25 is set at a high level. As a result, the N-MOS 57 is put in an ON state. Since the N-MOS 57 turns ON, an electric connection is established between the second control line 12 and the pixel electrode 21. When an image signal of a low level is inputted into the pixel 52, the terminal N1 of the capacitor 25 is set at a low level. As a result, the P-MOS 56 is put in an ON state. Since the P-MOS 56 turns ON, an electric connection is established between the first control line 11 and the pixel electrode 21.

As in the switching operation of the pixel 2 according to the foregoing first embodiment of the invention, the switching circuit 55 of the pixel 52 according to the first configuration example of the present embodiment of the invention performs switching operation on the basis of the potential of an image signal that is inputted into the capacitor 25. The selected one of the first control line 11 and the second control line 12 becomes connected to the pixel electrode 21. As a result, either the voltage level S1 of the first control line 11 or the voltage level S2 of the second control line 12 is inputted into the pixel electrode 21.

### Second Configuration Example

FIG. 9 is a diagram that schematically illustrates an example of the circuit configuration of a pixel 62 according to the second configuration example of the second embodiment of the invention. The pixel 62 illustrated in FIG. 9 includes a switching circuit 65, which is made up of two P-MOSs 66 and 67 (i.e., the first transistor and the second transistor) and the signal generation circuit 38, as a substitute for the switching circuit 35 of the pixel 2 illustrated in FIG. 2. In the following description of the second configuration example and the illustration of FIG. 9, the same reference numerals are consistently used for the same components as those illustrated in FIG. 2 so as to omit any redundant explanation or simplify explanation thereof.

In the circuit configuration of the pixel 62, the switching circuit 65 is connected between the terminal N1 of the capacitor 25 and the pixel electrode 21. As described above, the switching circuit 65 is provided with the two P-MOSs 66 and 67 as well as the signal generation circuit 38 The signal generation circuit 38 is, for example, an inverter that is made up of the P-MOS 38p and the N-MOS 38n. The signal generation circuit 38 is interposed between the terminal N1 and the terminal N2, the latter of which is connected to the gate terminal of the P-MOS 67. Therefore, the terminal corresponding to the input of the signal generation circuit 38 is the terminal N1. The terminal corresponding to the output of the signal generation circuit 38 is the terminal N2. The terminal N1 is connected to the gate terminal of the P-MOS 66. The terminal N2 is connected to the gate terminal of the P-MOS 67. The source terminal of the P-MOS 66 is connected to the first control line 11. The drain terminal of the P-MOS 66 is connected to the pixel electrode 21. The source terminal of the P-MOS 67 is connected to the second control line 12. The drain terminal of the P-MOS 67 is connected to the pixel electrode 21.

When an image signal of a low level is inputted into the pixel 62 having the configuration explained above, the terminal N1 of the capacitor 25 is set at a low level. As a result, the P-MOS 66 is put in an ON state. Since the P-MOS 66 turns ON, an electric connection is established between the first control line 11 and the pixel electrode 21. When an image signal of a high level is inputted into the pixel 62, the terminal N1 of the capacitor 25 is set at a high level. As a result, the terminal N2 is set at a low level. Since the level of the terminal N2 is low, the P-MOS 67 is put in an ON state. Therefore, an electric connection is established between the second control line 12 and the pixel electrode 21.

As in the switching operation of the pixel 2 according to the foregoing first embodiment of the invention, the switching circuit 65 of the pixel 62 according to the second configuration example of the present embodiment of the invention performs switching operation on the basis of the potential of an image signal that is inputted into the capacitor 25. The selected one of the first control line 11 and the second control line 12 becomes connected to the pixel electrode 21. As a result, either the voltage level S1 of the first control line 11 or the voltage level S2 of the second control line 12 is inputted into the pixel electrode 21.

### Third Configuration Example

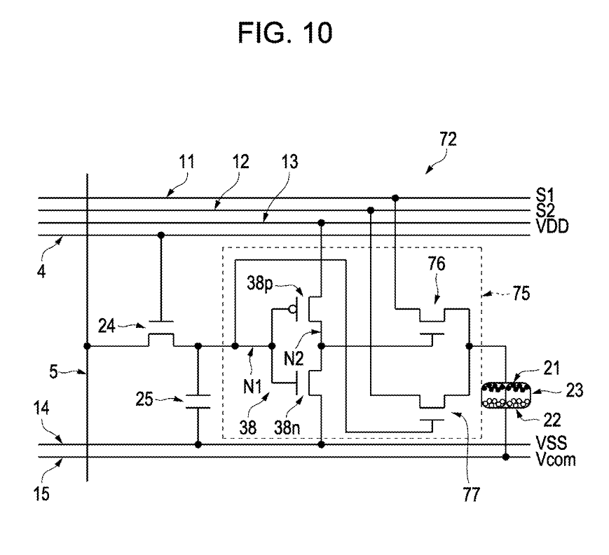

FIG. 10 is a diagram that schematically illustrates an example of the circuit configuration of a pixel 72 according to the third configuration example of the second embodiment of the invention. The pixel 72 illustrated in FIG. 10 includes a switching circuit 75, which is made up of two N-MOSs 76 and 77 (i.e., the first transistor and the second transistor) and the signal generation circuit 38, as a substitute for the switching circuit 35 of the pixel 2 illustrated in FIG. 2. In the following description of the third configuration example and the illustration of FIG. 10, the same reference numerals are consistently used for the same components as those illustrated in FIG. 2 so as to omit any redundant explanation or simplify explanation thereof.

In the circuit configuration of the pixel 72, the switching circuit 75 is connected between the terminal N1 of the capacitor 25 and the pixel electrode 21. As described above, the switching circuit 75 is provided with the two N-MOSs 76 and 77 as well as the signal generation circuit 38 The signal generation circuit 38 is, for example, an inverter that is made up of the P-MOS 38p and the N-MOS 38n. The signal generation circuit 38 is interposed between the terminal N1 and the terminal N2, the latter of which is connected to the gate terminal of the N-MOS 76. Therefore, the terminal corresponding to the input of the signal generation circuit 38 is the terminal N1. The terminal corresponding to the output of the signal generation circuit 38 is the terminal N2. The terminal N1 is connected to the gate terminal of the N-MOS 77. The terminal N2 is connected to the gate terminal of the N-MOS 76. The source terminal of the N-MOS 76 is connected to the first control line 11. The drain terminal of the N-MOS 76 is connected to the pixel electrode 21. The source terminal of the N-MOS 77 is connected to the second control line 12. The drain terminal of the N-MOS 77 is connected to the pixel electrode 21.

When an image signal of a high level is inputted into the pixel 72 having the configuration explained above, the terminal N1 of the capacitor 25 is set at a high level. As a result, the N-MOS 77 is put in an ON state. Since the N-MOS 77 turns ON, an electric connection is established between the second control line 12 and the pixel electrode 21. When the level of the terminal N1 is high, the level of the terminal N2 is low, which puts the N-MOS 76 in an OFF state. Accordingly, the pixel electrode 21 is disconnected from the first control line 11. When an image signal of a low level is inputted into the pixel 72, the terminal N1 of the capacitor 25 is set at a low level. As a result, the terminal N2 is set at a high level. Since the level of the terminal N2 is high, the N-MOS 76 is put in an ON state. Therefore, an electric connection is established between the first control line 11 and the pixel electrode 21. Since the level of the terminal N1 is low, the N-MOS 77 is set in an OFF state. Accordingly, the pixel electrode 21 is disconnected from the second control line 12.

As in the switching operation of the pixel 2 according to the foregoing first embodiment of the invention, the switching circuit 75 of the pixel 72 according to the third configuration example of the present embodiment of the invention performs switching operation on the basis of the potential of an image signal that is inputted into the capacitor 25. The selected one of the first control line 11 and the second control line 12 becomes connected to the pixel electrode 21. As a result, either the voltage level S1 of the first control line 11 or the voltage level S2 of the second control line 12 is inputted into the pixel electrode 21.

Each of the three configuration examples described above makes the configuration of a pixel circuit simpler than that of the pixel 2 according to the foregoing first embodiment of the invention (refer to FIG. 2). In addition, the area size of a pixel circuit can be reduced because of the reduced number of transistors. Therefore, it is possible to make an area per pixel, that is, an area occupied by each pixel, smaller. The smaller area per pixel makes it further possible to achieve finer array of pixels. Thus, an electrophoretic display device featuring high-definition pixel display is provided. In addition, the smaller number of transistors results in a reduction in parasitic capacitance when a current is applied. Thus, power consumption can be reduced.

The driving method of the present embodiment of the invention is the same as that of the first embodiment of the invention. Therefore, no further explanation is given here.

As in the configuration of an electrophoretic display device according to the first embodiment of the invention, at least one transistor is interposed between the capacitor 25 and the pixel electrode 21 in each of the first, second, and third configuration examples of the present embodiment of the invention. With such a configuration, charge stored at the capacitor 25 is less susceptible to leakage through the pixel electrode 21 than otherwise. Accordingly, it is possible to retain an image signal at the capacitor 25 for a longer period of time.

### Electronic Apparatus

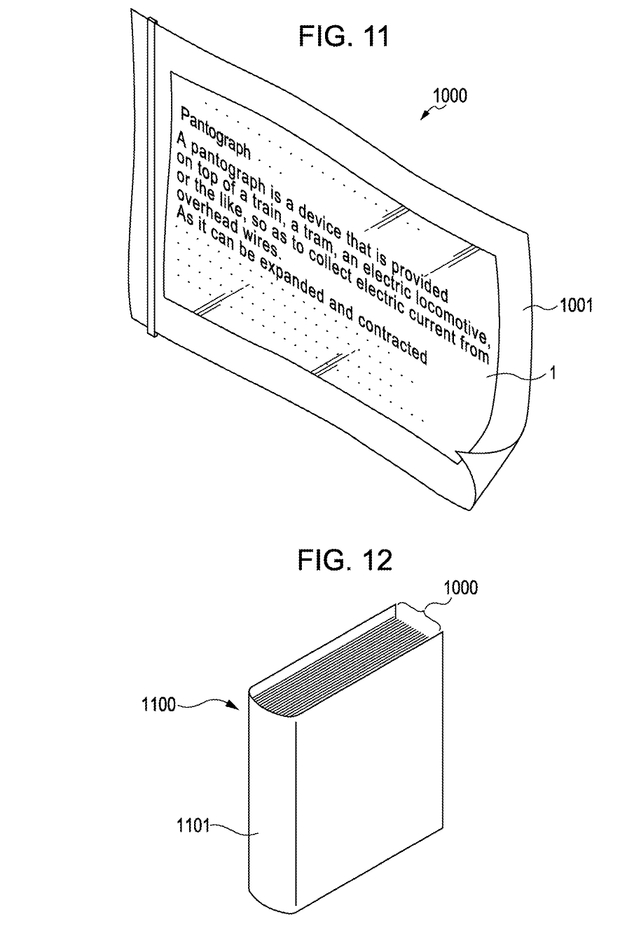

In the following description, a few examples of an electronic apparatus that is provided with the electrophoretic display device described above are explained with reference to FIGS. 11 and 12. As a first example, a flexible sheet of electronic paper to which an electrophoretic display device according to any of the foregoing exemplary embodiments of the invention is applied is explained. FIG. 11 is a perspective view that schematically illustrates an example of the configuration of a sheet of electronic paper. Electronic paper 1000 includes the electrophoretic display device 1 functioning as its display area. A main body 1001 of the electronic paper 1000 is made of a sheet material that has almost the same texture and flexibility as those of conventional paper (i.e., normal non-electronic paper). The electrophoretic display device 1 is provided on the surface of the main body 1001 so as to constitute the electronic paper 1000. As a second example, FIG. 12 schematically illustrates an example of the configuration of an electronic notebook 1100 in a perspective view. The electronic notebook 1100 includes a plurality of sheets of the electronic paper 1000 illustrated in FIG. 11. The electronic notebook 1100 is further provided with a book jacket 1101, which covers the sheets of electronic paper 1000. The book jacket 1101 is provided with a display data input unit that inputs display data that has been sent from, for example, an external device. The display data input unit is not shown in the drawing. Having such a configuration, the electronic notebook 1100 illustrated in FIG. 12 is capable of changing and/or updating (i.e., overwriting) display content in accordance with the supplied display data without any need to unbind the electronic paper 1000. Among a variety of electronic apparatuses to which the electrophoretic display device according to an aspect of the invention could be embodied are, in addition to the electronic apparatus (electronic paper and electronic notebook) explained above with reference to FIGS. 11 and 12, a television, a viewfinder-type video tape recorder, a video tape recorder of a direct monitor view type, a car navigation device, a pager, an electronic personal organizer, an electronic calculator, a word processor, a workstation, a videophone, a POS terminal, a touch-panel device, and so forth. The electrophoretic display device 1 can be adopted as the display unit of a variety of electronic apparatuses including but not limited to those enumerated above. Since an electronic apparatus described as the above examples is provided with an electrophoretic display device according to any of the foregoing exemplary embodiments of the invention as its display unit, it is possible to reduce the leakage of a current between two pixels arrayed adjacent to each other, reduce power consumption, and improve reliability. Moreover, if an electronic apparatus is provided with an electrophoretic display device according to the second embodiment of the invention, it is possible to make an area occupied by each pixel smaller. Thus, an electronic apparatus that includes an electrophoretic display device featuring a high-definition display area is provided.

### Variation Example

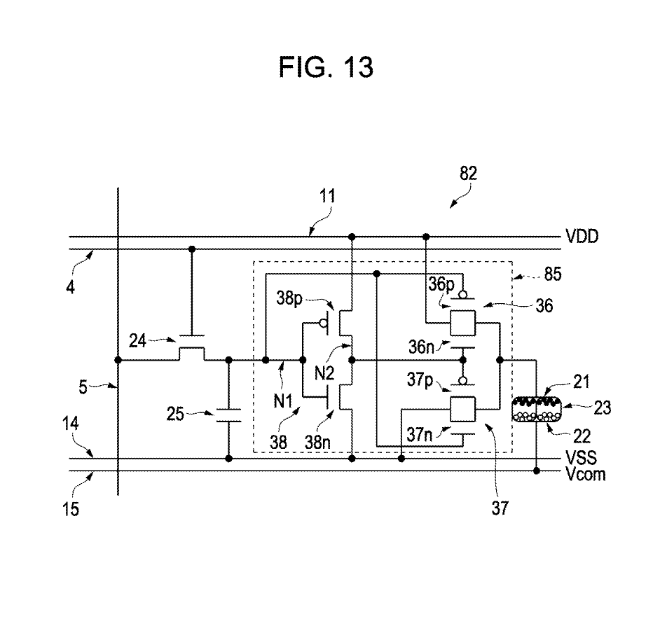

The first power supply line 13 and the second power supply line 14 may be omitted in the configuration of an electrophoretic display device according to any of the foregoing exemplary embodiments of the invention. FIG. 13 is a diagram that schematically illustrates an example of the circuit configuration of a pixel according to a variation example in which a line doubles as a control line and a power supply line. For example, if the potential of the first control line 11 is always the same as the potential of the first power supply line 13 and further if the potential of the second control line 12 is always the same as the potential of the second power supply line 14 as in the first driving method illustrated in FIG. 6, the first control line 11 and the second control line 12 may serve as, in addition to its original control function, the first power supply line 13 and the second power supply line 14, respectively as in the configuration of a pixel 82 illustrated in FIG. 13, which is provided with a switching circuit 85. With such a configuration, it is possible to omit the first power supply line 13 and the second power supply line 14.

The entire disclosure of Japanese Patent Application No. 2008-256095, filed Oct. 1, 2008 is expressly incorporated by reference herein.

What is claimed is:

1. An electrophoretic display device comprising:
a pixel electrode;
a counter electrode that is provided opposite to the pixel electrode;
an electrophoretic element being sandwiched between the pixel electrode and the counter electrode;
a pixel switching element;
a capacitor that is connected to the pixel switching element;
a switching circuit that is provided between the capacitor and the pixel electrodes;
a first control line that is connected to the switching circuit; and
a second control line that is connected to the switching circuit,
wherein the switching circuit performs switching operation on the basis of a signal outputted from the capacitor for a connection state switchover so as to connect either the first control line or the second control line to the pixel electrode.

2. The electrophoretic display device according to claim 1, further comprising:
a scanning line that is connected to the pixel switching element;
a data line that is connected to the pixel switching element;
a pixel driving section that supplies an image signal to the capacitor through the data line via the pixel switching element; and
a level controlling section that is connected to the first control line, the second control line, and the counter electrode,
wherein the level controlling section supplies a voltage that is to be applied to the pixel electrode to the switching circuit through each of the first control line and the second control line and further supplies a rectangular wave that alternates between a first level and a second level for at least one cycle to the counter electrode, and
the first level and the second level correspond to levels supplied to the first control line and the second control line.

3. The electrophoretic display device according to claim 1, wherein the switching circuit includes a signal generation circuit that outputs a first signal and a second signal that are different from each other in accordance with the signal outputted from the capacitor, a first switching element that electrically connects the first control line to the pixel electrode upon receiving the first signal, and a second switching element that electrically connects the second control line to the pixel electrode upon receiving the second signal.

4. The electrophoretic display device according to claim 3, wherein the signal generation circuit is an inverter.

5. The electrophoretic display device according to claim 3, wherein the signal generation circuit is a level shifter.

6. The electrophoretic display device according to claim 3, wherein each of the first switching element and the second switching element is a transfer gate.

7. The electrophoretic display device according to claim 3, wherein each of the first switching element and the second switching element is an n-type transistor.

8. The electrophoretic display device according to claim 3, wherein each of the first switching element and the second switching element is a p-type transistor.

9. The electrophoretic display device according to claim 1, wherein the switching circuit includes a p-type transistor whose gate terminal is connected to an output terminal of the capacitor and an n-type transistor whose gate terminal is also connected to the output terminal of the capacitor; the p-type transistor is provided between the pixel electrode and either one of the first control line and the second control line; and the n-type transistor is provided between the pixel electrode and the other of the first control line and the second control line that is not connected to the p-type transistor.

10. The electrophoretic display device according to claim 1, wherein the electrophoretic display device includes a plurality of pixels, and each of the plurality of pixels has the pixel electrode, the counter electrode, the electrophoretic element, the pixel switching element, the capacitor, and the switching circuit, and
wherein each of the first control line and the second control line is a common line that is shared by the plurality of pixels.

11. The electrophoretic display device according to claim 1, wherein each of the first control line and the second control line doubles as a control line and another global line.

12. An electronic apparatus that is provided with the electrophoretic display device according to claim 1 as a display unit of the electronic apparatus.

13. A method for driving an electrophoretic display device, the electrophoretic display including:
a plurality of pixels, each of the plurality of pixels having:
a pixel electrode;
a counter electrode that is provided opposite to the pixel electrode;
an electrophoretic element being sandwiched between the pixel electrode and the counter electrode;
a pixel switching element;
a capacitor that is connected to the pixel switching element; and
a switching circuit that is provided between the capacitor and the pixel electrodes,
a first control line that is connected to each of the plurality of pixels;
a second control line that is connected to each of the plurality of pixels, and
the driving method comprising:
a first operation of inputting an image signal into the capacitor via the pixel switching element; and
a second operation of supplying a first level and a second level to the first control line and the second control line, respectively, operating the switching circuit on the basis of the signal outputted from the capacitor so as to input a level into the pixel electrode from either the first control line or the second control line, and inputting a rectangular wave that alternates between the first level and the second level for at least one cycle into the counter electrode.

14. The method for driving an electrophoretic display device according to claim 13, wherein a first image signal is inputted into the capacitor of each of pixels that display a first gradation whereas a second image signal is inputted into the capacitor of each of pixels that display a second gradation in the first operation, and the switching circuit is operated on the basis of the signal outputted from the capacitor that retains the first image signal in each of the pixels that display the first gradation so as to make the first control line connected to the pixel electrode whereas the switching circuit is operated on the basis of the signal outputted from the capacitor that retains the second image signal in each of the pixels that display the second gradation so as to make the second control line connected to the pixel electrode in the second operation.

15. The method for driving an electrophoretic display device according to claim 13, wherein signals having the same level are supplied to the first control line and the second control line so that all of the pixels display the same gradation in the second operation.

16. The method for driving an electrophoretic display device according to claim 13, wherein the second operation includes a first display operation of setting the first control line into an electrically disconnected high impedance state and supplying the second level to the second control line so as to switch the display of pixels that occupy at least a part of the display area over from the first gradation to the second gradation and a second display operation of supplying the first level to the first control line and setting the second control line into an electrically disconnected high impedance state so as to switch the display of pixels that occupy at least a part of the display area over from the second gradation to the first gradation.

17. The method for driving an electrophoretic display device according to claim 13, wherein the second operation includes a first display operation of setting the first control line at the same level as a level of the counter electrode and supplying the second level to the second control line so as to switch the display of pixels that occupy at least a part of the display area over from the first gradation to the second gradation and a second display operation of supplying the first level to the first control line and setting the second control line at the same level as a level of the counter electrode so as to switch the display of pixels that occupy at least a part of the display area over from the second gradation to the first gradation.

18. The method for driving an electrophoretic display device according to claim 16, wherein the first display operation and the second display operation are repeated so as to update a display image in the second operation.

19. The method for driving an electrophoretic display device according to claim 13, further comprising an operation of setting the capacitor, the switching circuit, and the counter electrode into an electrically disconnected high impedance state after the second operation.
